(19) United States
(12) Patent Application Publication
(10) Pub. No.: US 2011/0145212 A1
(43) Pub. Date: Jun. 16, 2011

(54) METHOD AND SYSTEM FOR PROVIDING MEDIA SERVICE

(75) Inventors: Won Suk Lee, Daejeon (KR); Kangchan Lee, Daejeon (KR); Jong Hong Jeon, Daejeon (KR); Sung Han Kim, Daejeon (KR); Min Kyo In, Daejeon (KR); Seung Yun Lee, Daejeon (KR)

(73) Assignee: ELECTRONICS AND TELECOMMUNICATIONS RESEARCH INSTITUTE, Daejeon (KR)

(21) Appl. No.: 12/966,563

(22) Filed: Dec. 13, 2010

(30) Foreign Application Priority Data
Dec. 14, 2009 (KR) 10-2009-0123869
Dec. 3, 2010 (KR) 10-2010-0122979

(51) Int. Cl. G06F 17/30; G06F 15/16

(52) U.S. Cl. 707/705; 709/218; 707/E17.107

(57) ABSTRACT

In a method for providing a media service, the media service providing system retrieves an index file corresponding to a requested broadcast service after receiving a request for the broadcast service from the terminal. The media service providing system provides the retrieved index file to the terminal. Here, the index file includes a plurality of internet identifiers of a plurality of the media files corresponding to the broadcast service.

### CROSS-REFERENCE TO RELATED APPLICATION

This application claims priority to and the benefit of Korean Patent Application Nos. 10-2009-0123869 filed in the Korean Intellectual Property Office on Dec. 14, 2009 and 10-2010-0122979 filed in the Korean Intellectual Property Office on Dec. 3, 2010, the entire contents of which are incorporated herein by reference.

### BACKGROUND OF THE INVENTION

(a) Field of the Invention

The present invention relates to a method and system for providing a media service.

(b) Description of the Related Art

Recently, various media services such as YouTube of Google, Yahoo! Video, iTunes of Apple and flickr are provided through internet. Further, other services such as Video On Demand (VoD) service, Audio On Demand (AoD) service, Internet Protocol TeleVision (IPTV) service and real-time video/audio service are provided.

However, such broadcast services are based on a streaming server, which results in high cost. Because of utilizing various communication ports for providing services, it is difficult to provide services on the presence of firewall.

In addition, the advertisement inserted in the broadcasting enjoyed by a terminal through internet is provided indiscriminately by a content provider such as a broadcasting station without regard to the user's location or characteristic.

Since the advertisement is provided without consideration of the user's characteristic such as location, age and preferences, the effectiveness of the advertisement is low and the advertisement can't provide helpful information for the user.

Thus, a new method for providing advertisement based on the various characteristic information of a user is required.

### SUMMARY OF THE INVENTION

Aspects of the present invention provide a method and system for providing a media service based on HyperText Transfer Protocol (HTTP).

According to an aspect of the present invention, a method for providing a media service in a media service providing system is provided. The method includes receiving a request for a broadcast service from a terminal, retrieving an index file corresponding to the broadcast service, and providing the retrieved index file to the terminal.

The index file may include a plurality of internet identifiers of a plurality of the media files corresponding to the broadcast service.

The request for broadcast service may be received through HTTP and the retrieved index file may be provided to the terminal through the HTTP.

The plurality of internet identifiers may be arranged in order.

Each of the internet identifiers may represent a link of a one of the media files, and each of the internet identifiers may include Uniform Resource Identifier (URI) of a corresponding one of the media files.

Each media file may correspond to a portion of the broadcast service.

The broadcast service may be provided through the HTTP by at least one broadcasting content server that is indicated by the internet identifiers of the plurality of media files.

The index file may further comprise an internet identifier of at least one media file for an advertisement service. Here, the internet identifier of at least one media file for the advertisement service and the internet identifiers of the plurality of media files may be arranged in order in the index file.

The advertisement service may be provided through the HTTP by at least one advertising content server that is indicated by the internet identifier of at least one media file.

According to another aspect of the present invention, a method for receiving a media service in a terminal is provided. The method includes transmitting a request for a broadcast service to a media service providing system, receiving an index file corresponding to the broadcast service from the media service providing system, and receiving media files corresponding to a plurality of internet identifiers included in the index file.

According to yet another aspect of the present invention, a media service providing system including a database, a controller, and a transceiver is provided. The database stores a plurality of index files, wherein each of the index files comprises a plurality of internet identifiers of a plurality of media files corresponding a broadcasting service. The controller retrieves an index file corresponding to a broadcast service requested by a terminal from the database. The transceiver receives a request for the broadcast service from the terminal and provides the index file corresponding to the requested broadcast service to the terminal.

### BRIEF DESCRIPTION OF THE DRAWINGS

FIG. 1 is a diagram showing a media service providing system according to an embodiment of the present invention.

FIG. 2 is a flowchart showing a method for providing media service according to an embodiment of the present invention.

FIG. 3 and FIG. 4 show an index file and a corresponding server according to embodiments of the present invention, respectively.

FIG. 5 shows a segmentation of a media file according to an embodiment of the present invention.

FIG. 6 is a schematic diagram of a content providing server according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

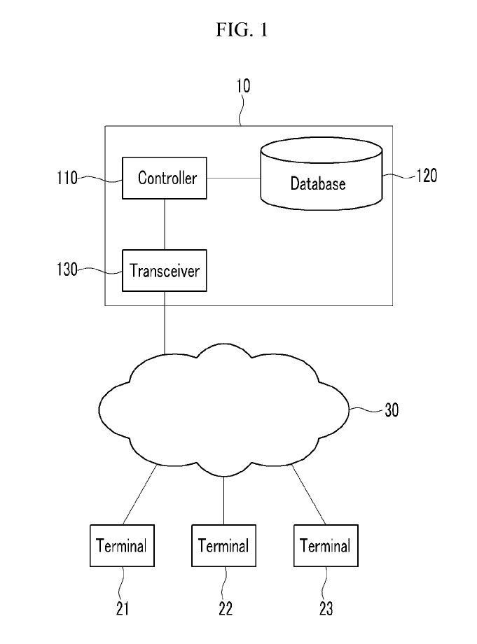

FIG. 1 is a diagram showing a media service providing system according to an embodiment of the present invention.

Referring to FIG. 1, a media service providing system 10 is connected to terminals 21, 22 and 23 such as a cell phone, a smart phone and an IPTV through internet 30, and provides to the terminals 21-23 video and/or audio broadcast service based on HyperText Transfer Protocol (HTTP). The media service providing system 10 includes a controller 110, a database 120, and a transceiver 130.

The database 120 stores index files for the broadcast service. The index file is a list of internet identifiers for media files corresponding to broadcast services. The internet identifier represents a link of media file and may be, for example, Uniform Resource Identifier (URI).

The controller 110 retrieve index files for the broadcast service requested by the terminals 21-23 from the database 120.

The transceiver 130 receives a broadcast service request from the terminals 21-23 through the HTTP, and transmits the index file extracted by the controller 110 to the terminals 21-23 through the HTTP.

After receiving the index file, the terminals 21-23 receive media files for the broadcast service in order listed in the index file through the HTTP and play the received media files. The terminals 21-23 may play media files and, at the same time, continuously receive media files that will be played afterward. The terminals 21-23 may prevent potential problems of the broadcast service by caching media files in consideration of bad communication environment.

Media files may be provided by the media service providing system 10 or other media providing systems. At this time, media files that are encoded with appropriate bit rate in consideration of the bandwidth of the network may be provided.

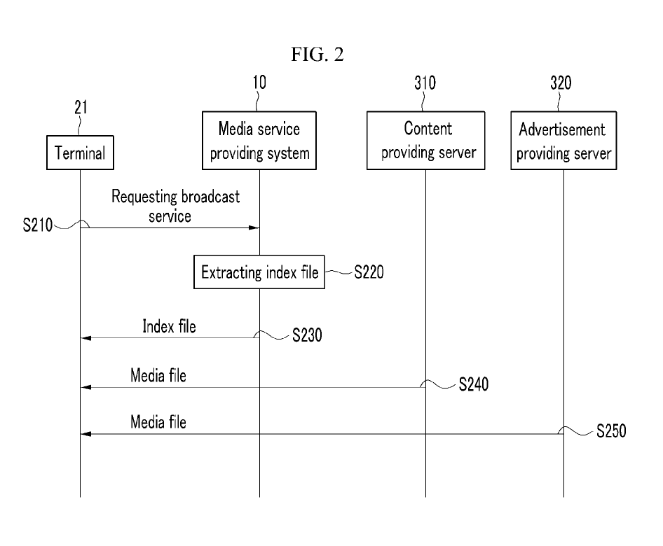

Hereinafter, a method for providing a media service according to an embodiment of the present invention will be described with reference to FIG. 2 to FIG. 6.

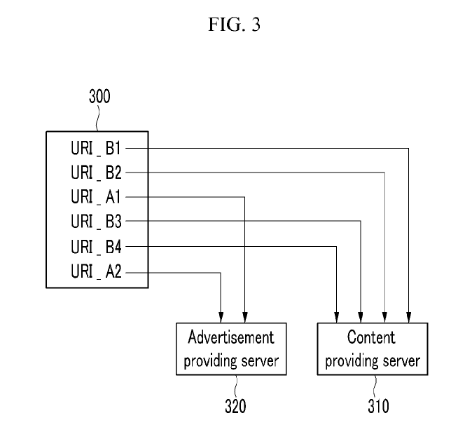

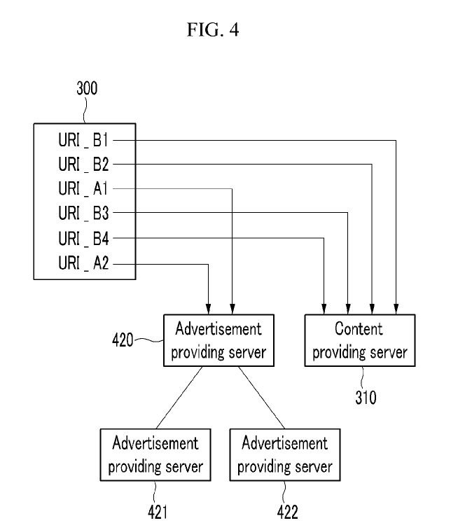

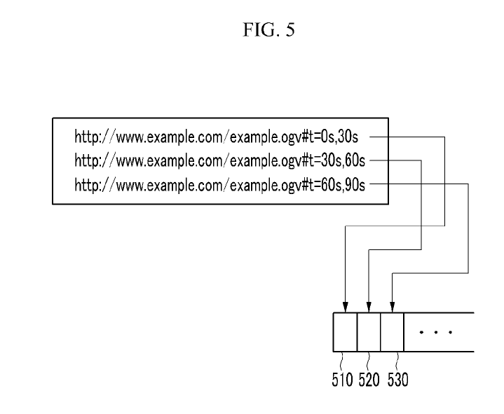

FIG. 2 is a flowchart showing a method for providing a media service according to an embodiment of the present invention. FIG. 3 and FIG. 4 show an index file and a corresponding server according to embodiments of the present invention, respectively. FIG. 5 shows a segmentation of a media file according to an embodiment of the present invention.

Referring to FIG. 2, the terminal 21 requests a broadcast service to the media service providing system 10 through HTTP (S210). The media service providing system 10 extracts at least one index file corresponding to the requested broadcast service among index files stored in the database 120 (S220). The media service providing system 10 transmits the extracted index file to the terminal 21 through the HTTP (S230).

Referring to FIG. 3, in the index file 300, at least one URI is arranged in the order. The at least one URI may include URIs (URI_A1, URI_A2) for an advertisement in addition to URIs (URI_B1, URI_B2, URI_B3, URI_B4) for the broadcast service. The URI for broadcast service is an internet identifier for a broadcasting media file provided by a content providing server 310, and the URI for the advertisement is an internet identifier for an advertisement media file provided by an advertisement providing server 320. The content providing server 310 and/or the advertisement providing server 320 may be an HTTP server and be located within or separate from the media service providing system 10.

Since there may exist a plurality of content providing servers, which service an media requested by the terminal 21, in internet, the media service providing system 10 may provide index file to the terminal 21 through the content providing server 310 that is most appropriate for the user of the terminal 21. Further, the media service providing system 10 may provide an index file of the advertisement media through the advertisement providing server 320 that is most appropriate for the user of the terminal 21. Then, since contents are provided to the terminal 21 based on the URI, the media service providing system 10 may provide a media caching service through a server or a communication equipment such as a content delivery network and a proxy server. Thus, an IP-based media service may be provided effectively.

Referring to FIG. 4, an advertisement providing server 420 according to another embodiment of the present invention acquires information on the location of the terminal 21 and provides a location-based advertisement. For example, the advertisement providing server 420 may determine the location of the terminal 21 by receiving at least one of GPS (global positioning system) information, information on the base station (not shown) where the terminal 21 is connected, IP address of the terminal 21, and the location information that is obtained through communication between the terminal 21 and the base station. In addition, the advertisement providing server 420 may provide advertisement for the subject in the user may be interested, for example restaurants, shopping malls and coffee shops near the user, based on the location of the terminal 21. For example, when the user of the terminal 21 uses the broadcast service in dinner time during a business trip to Jeju Island, the advertisement media for a restaurant that serves user's favorite menu among restaurants that are located near the user may be provided during the broadcast service.

As shown in FIG. 4, the advertisement providing server 420 may be connected to a plurality of advertisement providing servers 421 and 422, select a specific advertisement for the subject on which the user may have interest and then provide the user with the selected advertisement.

Referring to FIG. 2 again, the terminal 21 receives media files corresponding to the respective URIs in the order prescribed in the index file from the content providing server 310 and/or the advertisement providing server 320, and plays the media files (S240 and S250).

When the index file includes a plurality of URIs, each URI may represent a portion of an entire file for the broadcast service. For example, as shown in FIG. 5, the first URI (http://www.example.com/example.ogv#t=0s,30s) may indicate a file 510 for 0 to 30 seconds of the entire media file, the second URI (http://www.example.com/example.ogv#t=30s,60s) may indicate a file 520 for 30 to 60 seconds of the entire media file, and the third URI (http://www.example.com/example.ogv#t=60s,90s) may indicate a file 530 for 60 to 90 seconds of the entire media file. One media file may be automatically segmented by the file splitting unit or the settings for the advertisement media that are inserted into the broadcast service.

As described above, since the media service is provided by an HTTP server not a streaming server according to an embodiment of the present invention, various media services through internet can be easily provided. Further, since a service through the HTTP can be unaffected by a firewall and be associated with a server such as the CDN, the media service can be effectively provided under the various internet environments.

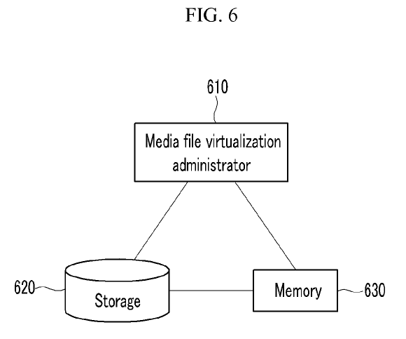

FIG. 6 is a schematic diagram of a content providing server according to an embodiment of the present invention.

Referring to FIG. 6, the content providing server includes a media file virtualization administrator 610, a storage 620 and a memory 630.

The storage 620 holds media files corresponding to URIs of an index file, and may be constituted of storage device such as a hard disk. The media file virtualization administrator 610 loads a specific portion of media file, which is expected to be requested by the terminal 21 in the segmented order of the media file, on the memory 630, and delete already serviced portion from the memory 630. The media file virtualization administrator 610 may include a start point and offset information on each part of the media file. As such, if a virtualization is performed by loading the specific portion of the media file that is expected to be serviced on the memory, the performance of the broadcast service can be improved by the memory 630 that have the relatively higher processing speed than the storage 620.

While the content providing server has been described as an example in FIG. 6, the advertisement providing server may be provided through the virtualization as shown in FIG. 6.

As described above, according to an embodiment of the present invention, since a media service can be provided based on the HTTP not the streaming server, it can be effectively provided under various internet environments.

Further, according to an embodiment of the present invention, the advertisement that is appropriate for the user can be provided.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a media service in a media service providing system, the method comprising:
receiving a request for a broadcast service from a terminal;
retrieving an index file corresponding to the broadcast service; and
providing the retrieved index file to the terminal,
wherein the index file comprises a plurality of internet identifiers of a plurality of media files corresponding to the broadcast service.

2. The method of claim 1, wherein the request for the broadcast service is received through hypertext transfer protocol (HTTP), and the retrieved index file is provided to the terminal through the HTTP.

3. The method of claim 1, wherein the plurality of internet identifiers are arranged in order.

4. The method of claim 1, wherein each of the internet identifiers represents a link of a corresponding one of the media files.

5. The method of claim 1, wherein each of the internet identifiers comprises Uniform Resource Identifier (URI) of a corresponding one of the media files.

6. The method of claim 1, wherein each media file corresponds to a portion of the broadcast service.

7. The method of claim 1, wherein the broadcast service is provided through the HTTP by at least one broadcasting content server that is indicated by the internet identifiers of the plurality of media files.

8. The method of claim 1, wherein the index file further comprises an internet identifier of at least one media file for an advertisement service.

9. The method of claim 8, wherein the internet identifier of at least one media file for the advertisement service and the internet identifiers of the plurality of media files are arranged in order in the index file.

10. The method of claim 8, wherein the advertisement service is provided through the HTTP by at least one advertising content server that is indicated by the internet identifier of at least one media file.

11. A method for receiving a media service in a terminal, the method comprising:
transmitting a request for a broadcast service to a media service providing system;
receiving an index file corresponding to the broadcast service from the media service providing system; and
receiving media files corresponding to a plurality of internet identifiers included in the index file.

12. The method of claim 11, wherein the plurality of internet identifiers are arranged in order in the index file, and receiving the media files comprises receiving the media files in order of the plurality of the internet identifiers.

13. The method of claim 11, wherein each of the internet identifiers represents a link of a corresponding one of the media files.

14. The method of claim 11, wherein each of the internet identifiers comprises Uniform Resource Identifier (URI) of a corresponding one of the media files.

15. The method of claim 11, wherein the request for the broadcast service is transmitted through HyperText Transfer Protocol (HTTP), the index file is received through the HTTP, and the media files are received is performed through the HTTP.

16. The method of claim 11, wherein the index file further comprises an internet identifier of at least one media file for a advertisement service, and an internet identifier of at least one media file for the advertisement service and the internet identifiers of the plurality of media files are arranged in order in the index file.

17. A media service providing system comprising:
a database configured to store a plurality of index files, wherein each of the index files comprises a plurality of internet identifiers of a plurality of media files corresponding a broadcasting service,
a controller configured to retrieve an index file corresponding to a broadcast service requested by a terminal from the database, and
a transceiver configured to receive a request for the broadcast service from the terminal and provide the index file corresponding to the requested broadcast service to the terminal.

18. The system of claim 17, wherein the transceiver receives the request for the broadcast service through hypertext transfer protocol (HTTP) from the terminal and provides the terminal with the index file corresponding to the requested broadcast service through the HTTP.

19. The system of claim 17, wherein each of the internet identifiers represents a link of a corresponding one of the media files.

20. The system of claim 17, wherein each of the internet identifiers comprises Uniform Resource Identifier (URI) of a corresponding one of the media files.
